(19) United States
(12) Patent Application Publication
(10) Pub. No.: US 2017/0235281 A1
(43) Pub. Date: Aug. 17, 2017

(54) APPARATUS AND METHOD FOR NOTIFYING A USER

(71) Applicant: CARISSA DAVINO, CHICAGO, IL (US)

(72) Inventor: CARISSA DAVINO, CHICAGO, IL (US)

(21) Appl. No.: 15/042,153

(22) Filed: Feb. 12, 2016

(51) Int. Cl. G04G 15/00; G08B 21/24

(52) U.S. Cl. CPC G04G 15/003; G08B 21/24

(57) ABSTRACT

An apparatus for notifying a user. The apparatus includes an adhesive, an input module, an alarm module, a power source, and a processing unit. The adhesive removably attaches the apparatus to a container. The input module receives a user input from the user. The alarm module delivers a notification to the user. The processing unit initiates a timer to track a duration of time after receiving the user input at the input module. The processing unit then compares the duration of time and the user input to determine whether to deliver the notification to the user, and operates the alarm module to deliver the notification to the user when the duration of time is greater than or equal to the user input.

### TECHNICAL FIELD

The present invention relates to an apparatus and method for notifying a user. Specifically, the present invention relates to an apparatus which may be removably attached to a container and notifies the user when to reapply the contents (e.g., sun screen, bug spray) of the container.

### BACKGROUND

The use of sun screen is most effective when the sun screen is regularly reapplied. Regular reapplication of sun screen according to health guidelines results in more protection from the sun's harmful rays. Similarly, bug spray should be reapplied regularly to ensure continuous protection from mosquito bites. Alternatively, some medications (e.g., pain killers) need to be taken at regular intervals, or a parent needs to attempt to feed a baby every so often. However, users of these products often forget to re-apply and/or re-use the products, resulting in diminished effectiveness.

One attempted solution, specifically for medications, has been to add electronics to the bottle caps that measure the number of medication pills consumed and can communicate with a pharmacy. This solution does not work well for consumables such as sun screen and bug spray. The caps are often expensive and cannot be transferred easily between containers.

Other attempted solutions have included using reminders on an external device (e.g., a smart phone). While users typically keep their phones near themselves often, sun screen and bug spray are used in locations where users want to limit the exposure of their phones to the environment (e.g., the sandy beach, the foggy forest).

Accordingly, an apparatus and method for notifying a user that is transferable between containers and does not require an external device would be desirable.

### SUMMARY

The present invention relates to an apparatus for notifying a user. The apparatus includes an adhesive, an input module, an alarm module, a power source, and a processing unit. The adhesive removably attaches the apparatus to a container. The input module receives a user input from the user. The alarm module delivers a notification to the user. The processing unit initiates a timer to track a duration of time after receiving the user input at the input module. The processing unit then compares the duration of time and the user input to determine whether to deliver the notification to the user, and operates the alarm module to deliver the notification to the user when the duration of time is greater than or equal to the user input.

The present invention also relates to an apparatus for notifying a user. The apparatus includes a packaging, an input module, an alarm module, a power source, and a processing unit. The packaging of the apparatus is integrated into a container. The input module receives a user input from the user. The alarm module delivers a notification to the user. The processing unit initiates a timer to track a duration of time after receiving the user input at the input module. The processing unit then compares the duration of time and the user input to determine whether to deliver the notification to the user, and operates the alarm module to deliver the notification to the user when the duration of time is greater than or equal to the user input.

The present invention further relates to a method for notifying a user. The method includes the steps of attaching an apparatus to a container using an adhesive and receiving a user input from the user at an input module. The method further includes the steps using a processing unit to initiate a timer to track a duration of time after receiving the user input and compare the duration of time and the user input to determine whether to deliver a notification to the user. An alarm module delivers the notification to the user when the duration of time is greater than or equal to the user input.

Other advantages and features of the disclosure will become apparent upon review of the detailed description and accompanying drawings.

### BRIEF DESCRIPTION OF THE DRAWINGS

FIGS. 1A through 1C illustrate various views of an apparatus in accordance with the principles of the present invention;

FIG. 2 illustrates an assembly of the apparatus, in accordance with the principles of the present invention;

FIG. 3 illustrates a block diagram of the apparatus, in accordance with the principles of the present invention;

FIG. 4 illustrates a system overview of a system using the apparatus for notifying a user, in accordance with the principles of the present invention;

FIGS. 5A through 5C illustrate various views of the apparatus, in accordance with the principles of the present invention; and

FIG. 6 illustrates a flowchart of a process for notifying a user using the apparatus, in accordance with the principles of the present invention.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

Accordingly, the detailed discussion herein of one or more embodiments is not intended, nor is to be construed, to limit the metes and bounds of the patent protection afforded the present invention, in which the scope of patent protection is intended to be defined by the claims and equivalents thereof. Therefore, embodiments not specifically addressed herein, such as adaptations, variations, modifications, and equivalent arrangements, should be and are considered to be implicitly disclosed by the illustrative embodiments and claims described herein and therefore fall within the scope of the present invention.

Additionally, it is important to note that each term used herein refers to that which a person skilled in the relevant art would understand such term to mean based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

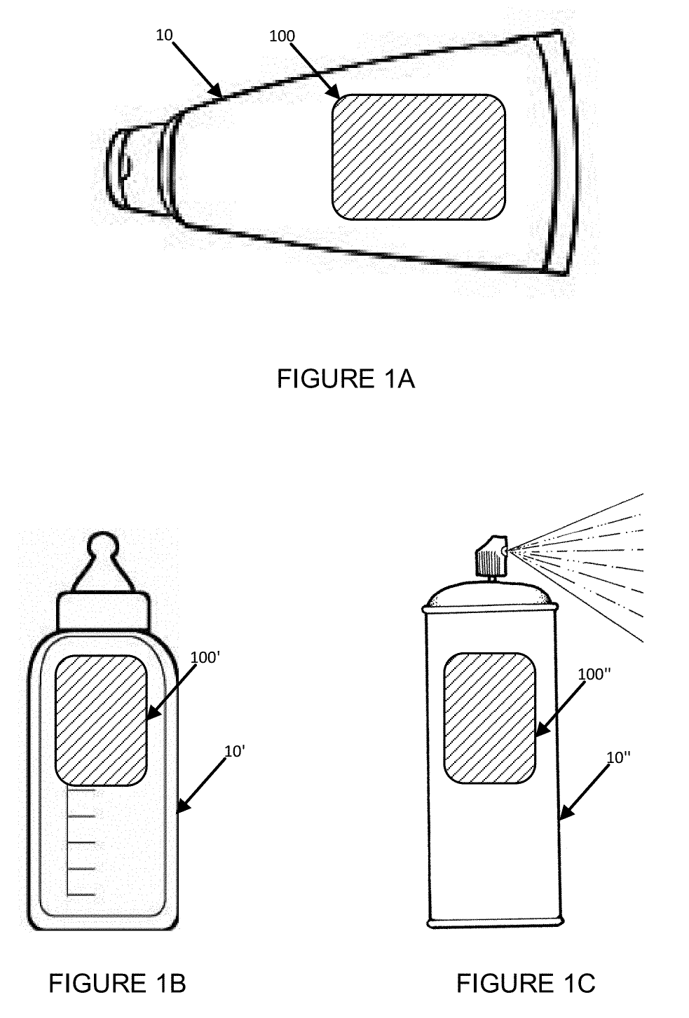

FIGS. 1A through 1C illustrate an apparatus 100, 100′, and 100″ in accordance with an embodiment of the present invention. In FIG. 1A, the apparatus 100 is applied to a container 10, for example, a bottle of sun screen. In some embodiments, the apparatus 100 is removably attached to the container 10 by a user. In other embodiments, the apparatus 100 is integrated into the container 10 during manufacturing. The apparatus 100 in this embodiment reminds the user to re-apply sun screen after a period of time (e.g., 20 to 60 minutes), typically based on guidelines from health organizations.

In the embodiment illustrated in FIG. 1B, the apparatus 100′ is applied to a container 10′, for example, a bottle of baby feed and/or medication. In some embodiments, the apparatus 100′ is removably attached to the container 10′ by a user. In other embodiments, the apparatus 100′ is integrated into the container 10′ during manufacturing. The apparatus 100′ reminds the user to take a dose of medication and/or attempt feeding a child after a period of time (e.g., 2 to 4 hours), typically based on a doctor's prescription or recommendation.

In the embodiment of FIG. 1C, the apparatus 100″ is applied to a container 10″, for example, an aerosol can of bug spray and/or sun screen. In some embodiments, the apparatus 100″ is removably attached to the container 10″ by a user. In other embodiments, the apparatus 100″ is integrated into the container 10″ during manufacturing. The apparatus 100″ reminds the user to re-apply bug spray after a period of time (e.g., 1 to 2 hours), typically based on guidelines from health organizations.

The apparatus 100, 100′, and 100″ depicted in FIGS. 1A through 1C has a rectangular shape, but other shapes may be used. A person skilled in the art would have sufficient knowledge to understand that the apparatus 100 can have a shape such as, but not limited to, circular, triangular, or even an undefined shape which could be substantially elliptical, and/or substantially oblong. In one embodiment, the apparatus 100 is approximately 1.5 inches wide and 1 inch long.

The container 10, 10′, and 10″ depicted in FIGS. 1A through 1C may be composed of a variety of materials. In some embodiments, the container 10, 10′, and 10″ is composed of a metal such as, for example, but not limited to, aluminum, steel, tin-plated steel, and aluminum alloys. In other embodiments, the container 10, 10′, and 10″ is composed of a plastic such as, for example, but not limited to, polyethylene terephthalate (“PET”), high density and/or low density polyethylene, polycarbonate, and bioplastic. It is also contemplated that the container 10 may be composed of porcelain or any other material configured to have a surface upon which an apparatus as in the present invention could be removably or fixedly incorporated. In some embodiments, the apparatus 100, 100′, 100″ includes an adhesive operable to removably attach to a plurality of types of materials, for instance but not limited to metal and/or plastic.

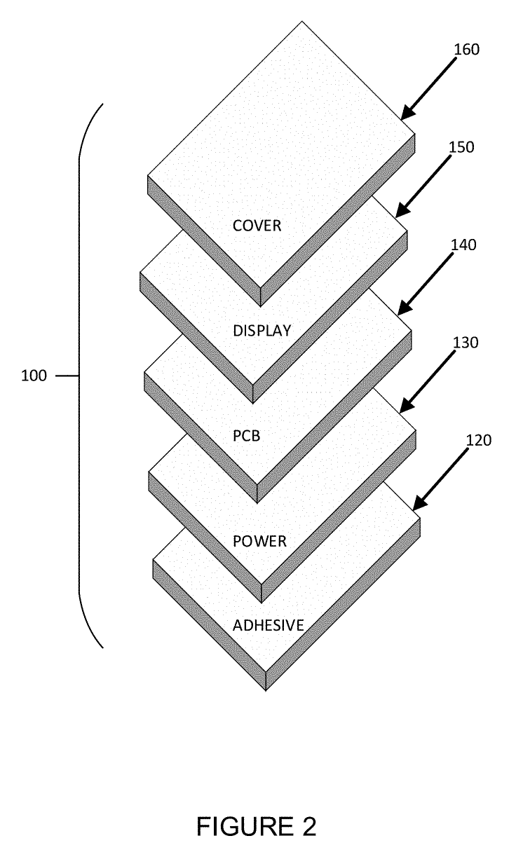

FIG. 2 illustrates an assembly view of the apparatus 100 in accordance with an embodiment of the present invention. The apparatus 100 includes a plurality of layers—an adhesive layer 120, a power layer 130, an electronics layer 140, a display layer 150, and a cover layer 160. The shape and order of the layers 120 through 160 within the apparatus 100 in FIG. 2 are for illustrative purposes. Other shapes and orders are possible and known to people skilled in the art. Preferably, the power layer 130, the electronics layer 140, and the display layer 150 are disposed between the adhesive layer 120 and the cover layer 140, so that the adhesive layer 120 and the cover layer 140 protect the layers 130 through 150 from damage. In some embodiments, the power layer 130 and the display layer 150 are part of the electronics layer 140, for example, as components. In some embodiments (e.g., the apparatus 100 integrated into the container 10), the adhesive layer 120 is a second cover layer that provides protection to parts of the apparatus 100 but no adhesive capabilities.

The adhesive layer 120 is operable to removably attach the apparatus 100 to the container 10. A user is able to attach the apparatus 100 to a first container and use the apparatus 100 for notifications, then remove the apparatus 100 and use it on a second container for notification, or store the apparatus 100 for later use. In some embodiments, the adhesive layer 120 is a glue and/or a tape. If the adhesive layer 120 is a glue and/or a tape, the adhesive layer 120 may further include a liner (not shown) to preserve the strength of the glue and/or the tape. In other embodiments, the adhesive layer 120 is a micro-fiber. The micro-fiber is composed of microscopic fabric (i.e., hairs) that can conform and attach to many surface shapes and materials. In yet other embodiments, the adhesive layer is a magnet, operable to attach the apparatus 100 to a container 10 composed of a ferromagnetic material.

The power layer 130 provides electrical power to components on the electronics layer 140 and the display layer 150. The power layer 130 may be, for example, a battery. The battery can be rechargeable, can be recharged/charged via induction charging, and/or can be charged by a wall electrical outlet, and/or by accommodating a USB to a computer to recharge/charge. In some embodiments, the power layer 130 receives a lithium battery, a lithium-ion battery, a nickel-cadmium (“NiCd”) battery, a nickel-metal hydride (“NiMH”) battery, or another suitable battery type.

Alternatively, the power layer 130 may include, for example, an energy harvesting transducer. A transducer converts variations in a physical quantity, such as light, movement, and temperature, into electrical power. Low amounts of power (e.g., several μW and/or mW) may be harvested from the container 10 and/or the environment) and used to power the apparatus 100. Alternatively, the harvested power may first be stored in a battery and later used to power the apparatus 100. In one embodiment, the power layer 130 includes a photovoltaic cell operable to convert light (i.e., sunlight) to electrical power. The power layer 130 with the photovoltaic cell would work well for the apparatus 100 on a container 10 used outdoors, for example, sun screen or bug spray. In another embodiment, the power layer 130 includes a piezoelectric cell operable to convert motion (i.e., vibrations) to electrical power. In yet another embodiment, the power layer 130 includes a temperature differential cell operable to convert the temperature difference between the container 10 (i.e., the contents of the container 10) and the environment into electrical power. A plurality of energy harvesting transducers may be used on the power layer 130.

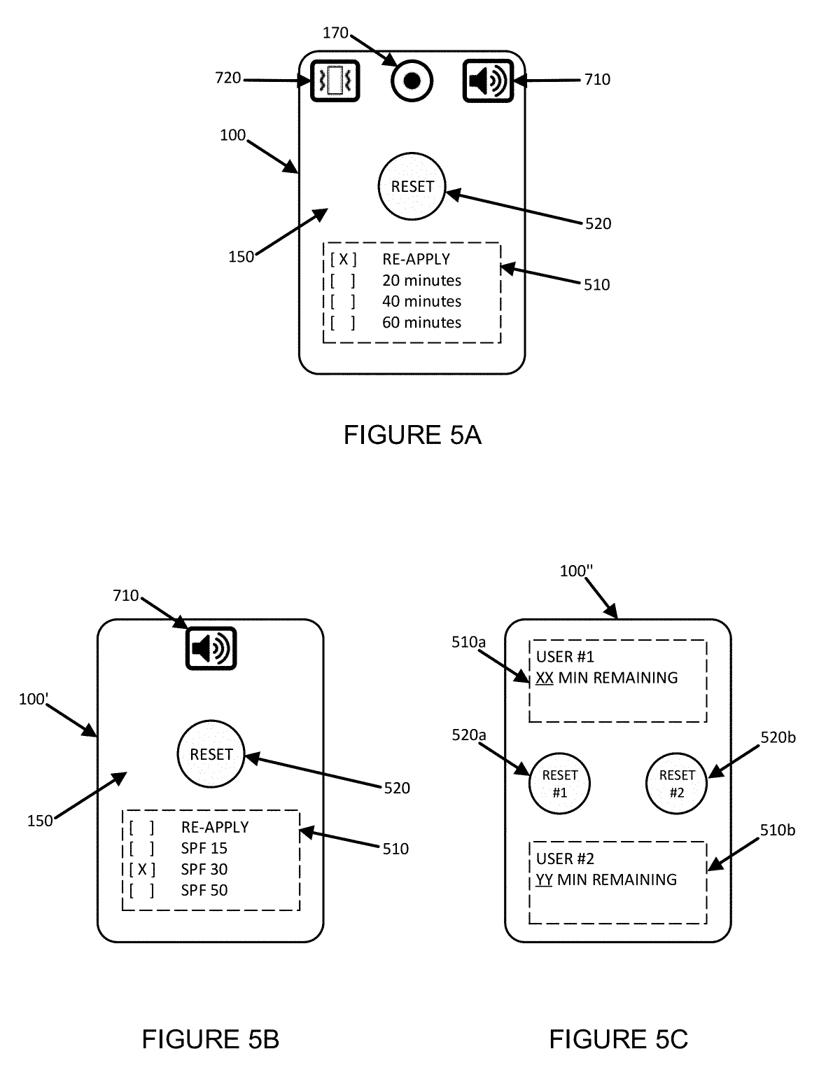

The electronics layer 140 (i.e., a printed circuit board [“PCB”]) may include, for example, but not limited to, a processing unit, a memory unit, a plurality of timers, and other suitable electrical components (more detail in reference to FIG. 5). Electronic components of the apparatus 100 are fixed to the PCB 140, which mechanically supports and electrically connects components of the apparatus 100 using tracks, pads, and other features etched from conductive sheets laminated onto a non-conductive substrate. In some embodiments, the electronics layer 140 is composed of a synthetic material that is thin and flexible. A thin and flexible electronics layer 140 allows the apparatus 100 to conform to the shape of the container 10. A flexible electronics layer 140 is composed of materials such as, but not limited to, polyimide, polyethylene naphthalate, poletherimide, fluoropolymers, transparent conductive polyester, and other suitable materials for flexible electronics.

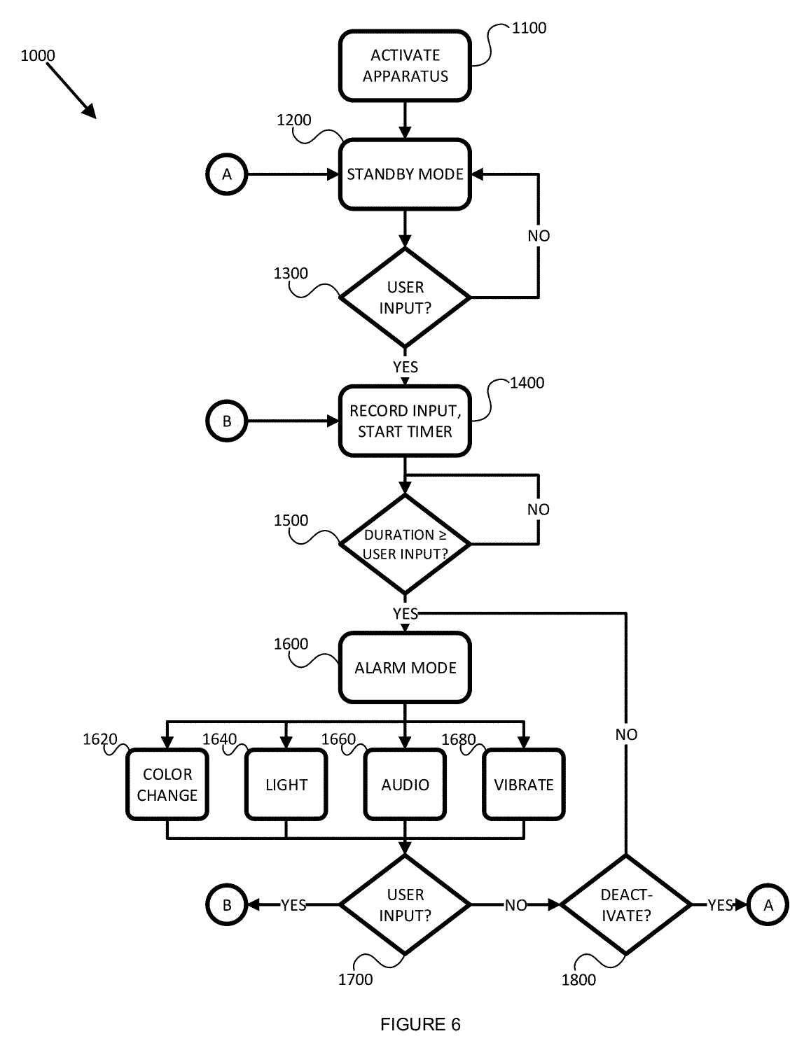

Referring to FIG. 2, the display layer 150 shows content to a user of the apparatus 100. The display layer 150 is operable to output visual signals such as, but not limited to, a changing color background, a menu for user selection, an image, and/or blinking lights. The display layer 150 is, for example, a liquid crystal display (“LCD;” monochrome or color), a light-emitting diode (“LED”) display, an organic LED (“OLED”) display, a thin-film transistor (“TFT”) LCD, or another suitable display technology. In some embodiments, the display layer 150 is flexible to conform to a shape of the container 10. In other embodiments, the entire display layer 150 or a part of the display layer 150 has touch screen capabilities (more detail in reference to FIGS. 5 and 6).

The cover 160 provides protection to the apparatus 100 from environmental factors, such as, but not limited to, dust particles, sand, scratches, moisture, spills, and oily deposits from a user's hand. The cover layer 160 may be composed of, for example, but not limited to, plastic, rubber, latex, glass, or another suitable material. A person skilled in the art would have sufficient knowledge of other suitable materials for cover layer 160 of the apparatus 100. The adhesive layer 120 through the cover layer 160 of the apparatus 100 may be attached to each other using an adhesive, such as glue and/or tape, or by a technique such as soldering.

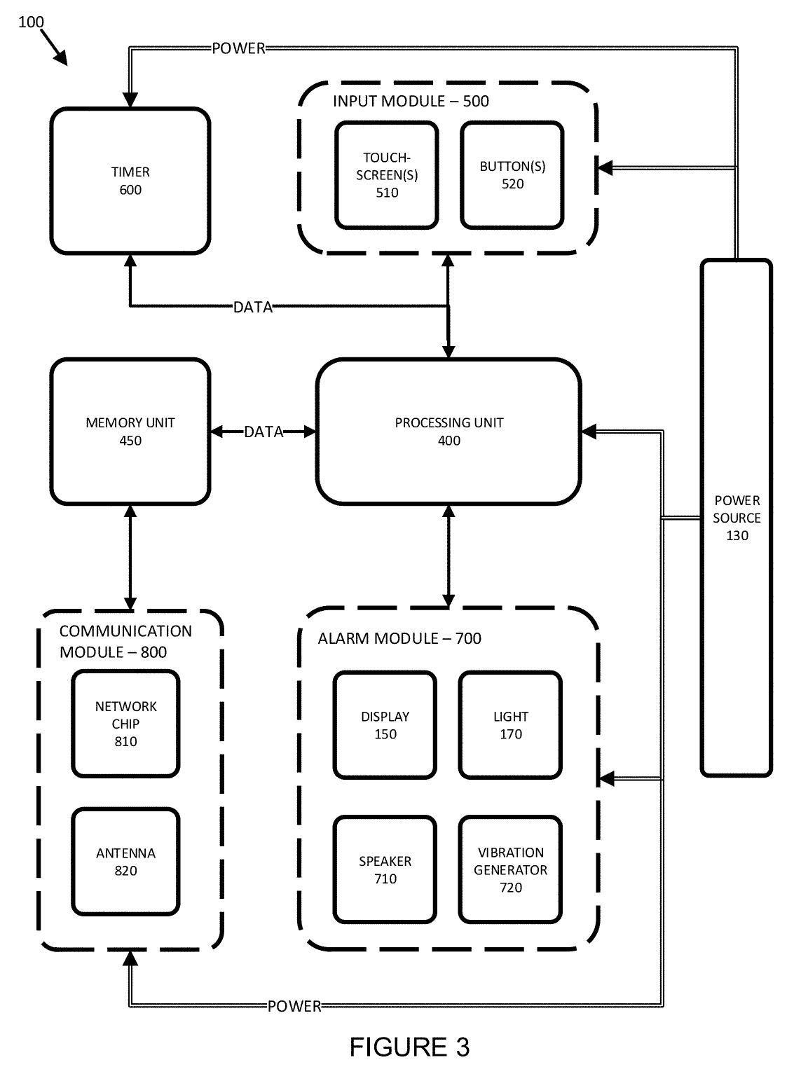

FIG. 3 illustrates the apparatus 100 in a block diagram format, in accordance with an embodiment of the present invention. A processing unit 400, a memory unit 450, an input module 500, a timer 600, an alarm module 700, and a communication module 800 are connected by one or more control and/or data buses (labeled “DATA”). The control and/or data buses are shown generally in FIG. 3 for illustrative purposes. The use of one or more control and/or data buses for the interconnection between and communication among the various modules and components would be known to a person skilled in the art in view of the present invention described herein.

The processing unit 400 of the apparatus 100 is, for example, but not limited to, a controller, processor, multiprocessor, microcontroller, or another suitable programmable device. The processing unit 400 includes a plurality of electrical and electronic components that provide power, operational control, and protection to the components and modules within the apparatus 100. In some embodiments, the processing unit 400 includes, among other things, a control unit, an arithmetic logic unit (“ALU”), and a plurality of registers, and is implemented using a known computer architecture, such as a modified Harvard architecture, a von Neumann architecture, etc. In some embodiments, the processing unit 400 is implemented partially or entirely on a semiconductor, for example, but not limited to, a field-programmable gate array [“FPGA”]) chip, such as a chip developed through a register transfer level (“RTL”) design process. In some embodiments, the processing unit 400 is composed of a plurality of processors.

The memory unit 450 of the apparatus 100 includes, for example, a program storage area and a data storage area. The program storage area and the data storage area may include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 400 is connected to the memory unit 450 and executes software instructions that are capable of being stored in a RAM of the memory unit 450, for example during execution, a ROM of the memory module, 600, for instance on a generally permanent basis, or another non-transitory computer readable medium such as another memory or a disc. Software included in the implementation of apparatus 100 can be stored in the memory unit 450. The software includes, for example, firmware, one or more applications, program data, filters, rules, one or more program modules, and other executable instructions. The processing unit 400 is configured to retrieve from memory and execute, among other things, instructions related to the control processes and methods described herein. Additionally, in some embodiments, the memory unit 450 may log information related to operation of the apparatus 100, such as the operation of the alarm module 700, the communication module 800, and/or the input module 500.

The input module 500 may include a plurality of touchscreens 510 and/or a plurality of actuators 520. The input module 500 is operable to receive a user input from a user. The plurality of touchscreens 510 may be part of the display layer 150. The plurality of touchscreens uses, for example, resistive and/or capacitive technology to detect the user input. In some embodiments, the touchscreen 510 is enabled by a coating (i.e., indium tin oxide [“ITO”]) on the display layer 150, wherein the coating is able to detect a distortion of the display layer 150 electrostatic field due to the user input (i.e., a finger touch).

The plurality of actuators 520 may be, but is not limited to, a switch, a button, a knob, and a dial. In some embodiments, the user actuating (i.e., pressing, flipping, tripping, manipulating) the actuator 520 may trigger the apparatus 400 to begin tracking a period of time and/or activate/deactivate the apparatus 400 (more detail in reference to FIG. 6).

The timer 600 (i.e., counter, oscillator) is operable to track a duration of time. In some embodiments, the timer 600 is located on the electronics layer 140. A plurality of timers 600 may be used in the apparatus 100. The processing unit 400 compares the duration of time from the timer 600 to a user input from the input module 600 to determine whether to operate the alarm module 700 (more detail in reference to FIG. 6). Alternatively, the processing unit 400 compares the duration of time from the timer 600 to a recorded input from the memory unit 450.

Referring to FIG. 3, the alarm module 700 includes the display 150 (i.e., the display layer 150 as described above with respect to FIG. 2), a light 170, a speaker 710, and a vibration generator 720.

In some embodiments, the display 150 displays a message to the user such as, for example, the duration of time remaining before the user should act (e.g., re-apply sun screen). In other embodiments, the display changes colors during operation of the apparatus. For example, at the initiation of the timer 600, the display 150 may be a first color (e.g., green). After a few minutes (e.g., three-fourths of the way through a duration of time defined by the user input) the display 150 may change to a second color (e.g., yellow). When the duration of the timer is equal to the user input, the display may change to a thing color (e.g., red), indicating to the user should act (see more detail in reference to FIGS. 5A through 5C). The light 170 is, for example, but not limited to, a light-emitting diode (“LED”). In some embodiments, the light 170 flashes when the processing unit 400 determines to deliver the notification to the user through the alarm module 700. In another embodiment, the color of the display may be a gradual change of color across time, illustrated from the top to the bottom of the apparatus 100 or from one side to the other side of the apparatus 100 linking change of color to time.

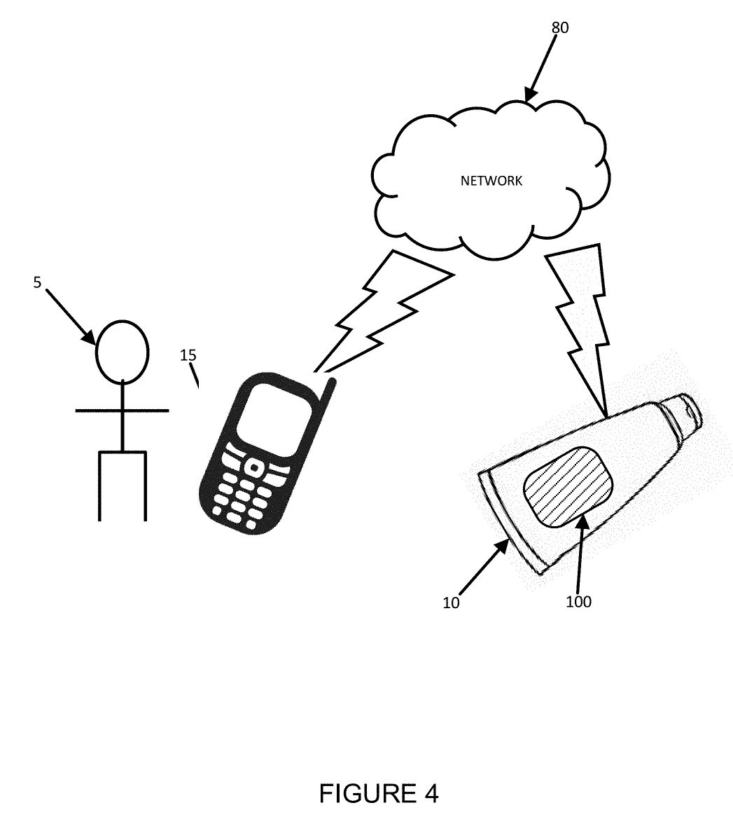

The speaker 710 outputs audio signals into the area around the apparatus 100 to notify the user. In some embodiments, the speaker 710 is operable to output audio signals such as, but not limited to, an alarm noise, a song, and/or a recorded message (e.g., a parent instructing a child to re-apply sunscreen). The audio signal may be based on a stored setting in a memory unit 450 or a signal transmitted from an external device connected to the apparatus 100 over a network (more detail in reference to FIG. 4). In other embodiments, a plurality of speakers 410 may be used. The speaker 710 is configured to accommodate and output various sounds depending on the user or automatic input. The speaker 710 may also output different sounds depending on the user whereby a plurality of users can be alerted via the same speaker 710 based on custom sounds for each user.

The vibration generator 720 outputs vibrations to notify the user (e.g., causing the container 10 to move). The vibration generator 720 uses, for example, a motor coupled to a plurality of weights. In some embodiments, a rotational motor causes the plurality of weights to rotate. Each of the plurality of weights may have a different mass, causing the motor and the plurality of weights to rotate unevenly; the uneven rotation leads to vibration. In other embodiments, a linear motor causes the plurality of weights to move. The vibration generator 720 is configured to accommodate and output various patterns of vibration depending on the user or automatic input. The vibration generator 720 may also output different patterns of vibration depending on the user whereby a plurality of users can be alerted via the same vibration generator based on a custom pattern for each user.

The processing unit 400 determines whether to operate the alarm module 700 based on a duration of time of the timer 600 and a user input received at the input module 500 (more detail in reference to FIG. 6). The alarm module 700 may use one or more of the display 150, the light 170, the speaker 710, and the vibration generator 720 to notify the user.

The communication module 800 may include, but is not limited to, a network chip 810 and an antenna 820. The network chip 810 enables communication via a network to an external device (more detail in reference to FIG. 4). The network chip 810 may be, for example, but not limited to, a Wi-Fi chip, a Bluetooth chip, or a GSM chip. The antenna 820 supports a connection between the apparatus 100 and the network. In some embodiments, a signal can be transmitted at real-time by the communication module 800 or stored in the memory unit 450 until a connection between the communication module 800 and the network is established. In other embodiments, Near Field Communication (“NFC”) or infrared (“IR”) technology is used to transmit signals using the communication module 800.

Referring to FIG. 3, the apparatus includes the power source 130 (i.e., the power layer 130 described above with respect to FIG. 2). Power is delivered to components of the apparatus 100 from the power source 130 over one or more power buses (labeled “POWER”). The power buses are shown generally in FIG. 3 for illustrative purposes. In some embodiments, power from the power source 130 may be conserved by placing the alarm module 700 in a standby mode (more detail in reference to FIG. 6). The power source 130 is preferably able to power to the apparatus 100 for at least several hours while the apparatus 100 is attached to the container 10.

FIG. 4 illustrates a system overview of a system 1 for notifying a user 5 in accordance with an embodiment of the present invention. An apparatus 100 is attached to a container 10. In some embodiments, a plurality of apparatuses 100 are attached to a single container 10, or the user 5 uses a plurality of apparatuses 100 on a plurality of containers 10 simultaneously. The apparatus 100 is operable to communicate with a network 80. In some embodiments, the apparatus 100 communicates with a router (not shown) within the house 100 to transmit signals to the network 80. In another embodiment, the apparatus 100 is simply provided with a battery and has preset parameters, and activating the same provides the user(s) with only what is preprogrammed or programmable in the PCB of the apparatus 100. In such an embodiment, the battery may well be rechargeable, however, the settings in the apparatus 100 are preset and are not programmable via a Bluetooth or wifi, or a network. In such an embodiment, for instance, a user may choose from A, whereby upon activation the user is notified at preset times via preset notification signals which could be sound and/or color and/or vibration, for example; B, providing a different timing setting; or C another timing setting. In such an embodiment, for example the user merely needs to determine the timing notification preference and/or the type of notification preferred. Even more simply, an embodiment could be provided with an integrated apparatus 100 whereby only one timer is present and only one notification style (i.e. vibration or color or sound or lights), and without a rechargeable battery, thereby accommodating a “disposable” version of the apparatus 100, whereby after the battery is no longer charged, the apparatus 100 is no longer effective. These embodiments are not intended to be limiting, but are merely illustrative.

A user 5 uses an external device 15 to transmit signals to and from the apparatus 100 using the network 80. The external device 15 may be, for example, but not limited to, a cellular phone, a personal computer, or a tablet. The external device 15 sends and receives signals from the apparatus 100 via the network 80. In other embodiments, the external device 15 is a single-function device that is only operable to communicate with the apparatus 100.

In some embodiments, an application operates on the external device 15. The application may be, for example, a smartphone application or a website. The application receives a user input such as, for example, pressing the user interface to indicate a user input related to starting a timer. The application is operable to transmit a first signal based on the user input to the apparatus 100 via the network 80. The application is further operable to receive a second signal, related to a notification for the user (e.g., from the alarm module 700), from the apparatus 100 via the network 80. The application presents the notification on the external device 15. The notification may be, for example, but not limited to, a message, a sound, or an image.

FIGS. 5A through 5C illustrate various views of the apparatus 100, in accordance with an embodiments of the present invention. In FIG. 5A, the display 150, the light 170, the touchscreen 510, the actuator 520, the speaker 710, and the vibration generator 720 are on a front face (i.e., facing away from the container 10, towards the user 5) of the apparatus 100. The user 5 selects a duration for the timer 600 (i.e., a user input) on the touchscreen 510. To start the timer 600, the user 5 actuates (i.e., presses) the “RESET” actuator 520. When the processing unit 400 determines that the timer is greater than or equal to the user input, the alarm module 700 notifies the user 5 via at least one of the display 150, the light 170, the speaker 720, and the vibration module. The display 150 may, for example, change from a first color (e.g., green) to a second color (e.g., red) to notify the user 5. The light 170 may, for example, flash to notify the user 5, the speaker 710 may output an audio signal, and the vibration generator 720 may vibrate.

In FIG. 5B, the display 150, the touchscreen 510, the actuator 520, and the speaker 710 are on a front face (i.e., facing away from the container 10, towards the user 5) of the apparatus 100′. The user 5 selects a Sun Protection Factor (“SPF”) rating (i.e., a user input) on the touchscreen 510. The processing unit 500 looks-up a duration of time corresponding to the SPF rating (e.g., based on health guidelines) in the memory unit 450. To start the timer 600, the user 5 actuates (i.e., presses) the “RESET” actuator 520. When the processing unit 400 determines that the timer is greater than or equal to the user input, the alarm module 700 notifies the user 5 via at least one of the display 150 and the speaker 720.

In FIG. 5C, a first touchscreen 510a, a second touchscreen 510b, a first actuator 520a, and a second actuator 520b are on a front face (i.e., facing away from the container 10, towards a plurality of users) of the apparatus 100″. A first user 5a selects a duration of time (i.e., a user input) on the first touchscreen 510a. To start a first timer 600a (not shown), the first user 5a actuates (i.e., presses) the first actuator 520a. Similarly, a second user 5b selects a duration of time (i.e., a user input) on the second touchscreen 510b. To start a second timer 600b (not shown), the second user 5b actuates (i.e., presses) the second actuator 520b. When the processing unit 400 determines that one of the timers 600a, 600b is greater than or equal to at least one of the user inputs, the alarm module 700 notifies the user 5 via the corresponding touchscreens 510a, 510b (e.g., by flashing and/or changing color, similar to display 150). The placement of the components 150, 170, 510, 520, 710, and 720 on the apparatus 100, 100′, and 100″ depicted in FIGS. 5A through 5C is merely for illustrative purposes; other placements are possible.

FIG. 6 illustrates a flowchart of a process 1000 for notifying a user, in accordance and embodiment of the present invention. The process 1000 is associated with and described herein with respect to the system 1 depicted in FIG. 4 involving the user 5 with the external device 15 and the apparatus 100 on the container 10. Various steps described herein with respect to the process 1000 are capable of being executed simultaneously, in parallel, or in an order that differs from the illustrated serial manner of execution. The process 1000 is also each capable of being executed using fewer steps than are shown in the illustrated embodiment

The process 1000 for notifying the user 5 begins with activating the apparatus 100 at step 1100. Activating the apparatus 100 may include, for example, but is not limited to, pressing the actuator 510 and/or touchscreen 520 for an extended period of time (e.g., 5 seconds). Once activated, the apparatus 100 operates in a standby mode (step 1200). During standby mode, the processing unit 400 performs minimal tasks. For example, the processing unit 400 will not initiate the timer 600, compare the timer 600 to a user input, operate the alarm module 600, or operate the communication module 800 during the standby mode (thus reducing power usage from the power source 130).

The processing unit 400 determines whether a user input has been received by the input module 500 at step 1300. A user input may be, for example, a time period and/or an SPF rating selected on the touchscreen 510, or actuating (i.e., pressing) the actuator 520. If no user input is received, the apparatus remains in standby mode (step 1200). If a user input is received at the input module 500, the processing unit 400 record the user input in the memory unit 450 and starts the timer 600 at step 1400.

In some embodiments, the timer 600 (i.e., counter, oscillator) tracks a duration of time from zero (i.e., begins counting at zero). The precision of the timer 600 may be, for example, seconds, milliseconds, microseconds, or another suitable measure of time. At step 1500, the processing unit 400 determines whether the duration of time of the timer 600 is greater than or equal to the user input (i.e., the time period). If the duration is not greater than or equal to the time period, the processing unit 400 continues repeating step 1500. If the duration is greater than or equal to the user input, the apparatus 100, in particular the alarm module 700 of the apparatus 100, operates in an alarm mode (step 1600).

Alternatively, in other embodiments, the timer 600 (i.e., counter, oscillator) counts down a duration of time starting at the user input (i.e., the time period). In such embodiments, at step 1500, the processing unit 400 determines whether the duration of time of the timer 600 is less than or equal to zero. If the duration is not less than or equal to zero (i.e., the duration is greater than zero), the processing unit 400 continues repeating step 1500. If the duration is less than or equal to zero, the apparatus 100, in particular the alarm module 700 of the apparatus 100, operates in an alarm mode (step 1600).

During the alarm mode at step 1600, the alarm module 700 delivers a notification to the user 5. As discussed above, the notification reminds the user 5 that an action should be performed such as, for example, re-applying sun screen and/or bug spray, taking a dosage of a medication, and/or attempting to feed a child. In some embodiments with a plurality of timers, there are two alarm modes (i.e., one for each of the plurality of timers), and the processing unit 400 checks the duration of time for each of the plurality of timers to determine whether to operate the alarm module 700 in the alarm mode (step 1600).

When the apparatus 100, more particularly the alarm module 700 of the apparatus 100, operates in the alarm mode, at least one of steps 1620, 1640, 1660, and 1680 is completed. In step 1620, the display 150 changes from a first color to a second color to notify the user 5. In step 1640, the light 170 flashes to notify the user 5. In step 1660, the speaker 710 outputs an audio signal (e.g., an alarm, a song, a voice recording) to notify the user 5. In step 1680, the vibration generator 720 vibrates to notify the user 5. In some embodiments, the communication module 800 may send a notification to the external device 15 to notify the user 5.

The processing unit 400 determines whether a user input has been received by the input module 500, since the beginning of the alarm mode 1600, at step 1700. If a user input has been received (e.g., pressing the actuator 520 and/or the touchscreen 510), the process returns to step 1400. If a user input has not been received, the processing unit 400 determines whether to deactivate the alarm mode at step 1800. The processing unit 400 may determine to deactivate, for example, but not limited to, when the apparatus 100 has been operating in alarm mode for a certain time (e.g., more than 5 minutes). If the processing unit 400 decides to deactivate, the apparatus returns to standby mode (step 1200). If the processing unit 400 does not decide to deactivate, the alarm mode continues (step 1600). In standby mode, the apparatus 100 will turn off (i.e., stop providing electrical power from the power source 130 to components) after a predetermined period of time (e.g., 10 minutes).

As to the manner of usage and operation of the present invention, the same should be apparent from the above description. Accordingly, no further discussion relating to the manner of usage and operation will be provided.

While an embodiment of the apparatus has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent to one skilled in the art, and all equivalent relationships to those illustrated in the drawings and described in the specification are intended to be encompassed by the present invention.

Throughout this specification, unless the context requires otherwise, the word “comprise” or variations such as “comprises” or “comprising” or the term “includes” or variations, thereof, or the term “having” or variations thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the invention given that the essential features of the invention as claimed are included in such an embodiment.

Those skilled in the art will appreciate that the invention described herein is susceptible to variations and modifications other than those specifically described, and that each embodiment is also provided with features that may be applicable to other embodiments. It is to be understood that the invention includes all such variations and modifications that fall within its spirit and scope. The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I/We claim:

1. An apparatus for notifying a user, the apparatus comprising:
an adhesive operable to removably attach the apparatus to a container;
an input module operable to receive a user input from the user;
an alarm module operable to deliver a notification to the user;
a power source; and
a processing unit configured to
initiate a timer, operable to track a duration of time, after receiving the user input at the input module,
compare the duration of time and the user input to determine whether to deliver the notification to the user, and
operate the alarm module to deliver the notification to the user when the duration of time is greater than or equal to the user input.

2. The apparatus of claim 1, wherein the processing unit is displaced on a synthetic material that is thin and flexible.

3. The apparatus of claim 1, wherein the adhesive is selected from the group comprising of a tape, a glue, a micro-fiber, and a magnet.

4. The apparatus of claim 1, wherein the input module consists of at least one selected from the group of a touchscreen and an actuator.

5. The apparatus of claim 1, wherein the alarm module consists of at least one selected from the group of a display, a speaker, a light, and a vibration generator.

6. The apparatus of claim 5, wherein the display is operable to change from a first color to a second color to deliver the notification to the user.

7. The apparatus of claim 1, wherein the power source is a battery selected from the group consisting of a lithium battery, a lithium-ion battery, and a rechargeable battery.

8. The apparatus of claim 1, wherein the power source is a harvesting transducer selected from the group of a photovoltaic cell, a piezoelectric cell, and a temperature differential cell.

9. The apparatus of claim 1, wherein the user input is a time period.

10. The apparatus of claim 1, wherein the user input is a Sun Protection Factor (“SPF”) rating.

11. The apparatus of claim 10, the processing unit further configured to find, in a memory unit, a time period corresponding to the SPF rating, and compare the duration of time tracked by the timer to the time period corresponding to the SPF rating.

12. The apparatus of claim 1, further comprising a protective cover, wherein the input module, the alarm module, the power source, and the processing unit are displaced between the adhesive and the protective cover.

13. An apparatus for notifying a user, the apparatus comprising:
a packaging operable to be integrated into a container;
an input module operable to receive a user input from the user;
an alarm module operable to deliver a notification to the user;
a power source; and
a processing unit configured to
initiate a timer, operable to track a duration of time, after receiving the user input at the input module,
compare the duration of time and the user input to determine whether to deliver the notification to the user, and
operate the alarm module to deliver the notification to the user when the duration of time is greater than or equal to the user input.

14. The apparatus of claim 13, wherein the container is selected from the group of a sun screen, a bug spray, a medication bottle, and a baby bottle.

15. The apparatus of claim 14, wherein the container is composed of a material selected from the group of a metal and a plastic.

16. The apparatus of claim 13, further comprising a communication module operable to transmit a signal from the alarm module to an external device to deliver the notification to the user.

17. The apparatus of claim 16, wherein the communication module is operable to receive a user input from the external device.

18. The apparatus of claim 13, further comprising a second timer, operable to track a second duration of time, wherein the input module is operable to receive a second user input from a second user, the processing unit is configured to initiate the second timer, compare the second duration of time to the second user input, and operate the alarm module to deliver a second notification to the second user.

19. An method for notifying a user, the method comprising:
attaching, using an adhesive, an apparatus to a container;
receiving, at an input module of the apparatus, a user input from the user;
initiating, using a processing unit, a timer after receiving the user input, wherein the timer is operable to track a duration of time;
comparing, at the processing unit, the duration of time and the user input to determine whether to deliver a notification to the user; and
delivering, using an alarm module, the notification to the user when the duration of time is greater than or equal to the user input.

20. The method of claim 19, wherein delivering, using the alarm module, the notification to the user consists of at least one selected from changing a color of a display, sounding an alarm, flashing a light, causing a vibration, and transmitting a signal to an external device.
